(19) United States
(12) Patent Application Publication
(10) Pub. No.: US 2008/0193582 A1
(43) Pub. Date: Aug. 14, 2008

(54) Extrusion Storage Head and Method for Producing Blow-Molded Multilayer Plastic Hollow Bodies

(75) Inventor: Peter Langos, St. Augustin (DE)

Correspondence Address: HENRY M FEIEREISEN, LLC;HENRY M FEIEREISEN, 708 THIRD AVENUE, SUITE 1501, NEW YORK, NY, 10017, US

(73) Assignee: Mauser-Werke GmbH, Bruhl (DE)

(21) Appl. No.: 11/913,808

(22) PCT Filed: May 5, 2006
(86) PCT No.: PCT/EP2006/004224

§ 371 Date: Nov. 7, 2007

(30) Foreign Application Priority Data
May 10, 2005 (DE) 20 2005 007 636.8

(51) Int. Cl. B29C 47/00

(52) U.S. Cl. 425/131.1

(57) ABSTRACT

The invention relates to an extrusion storage head (10) for a blow-molding machine and a method for production of blow-molded multi-layer plastic hollow bodies made from a two- or multi-layer pre-form, whereby two or more peripheral manifolds (16, 18) are arranged above a storage reservoir (20), from which the peripherally-extruded plastic may be sequentially ejected as a tubular parison from a controlled annular nozzle (24) by means of an ejector piston (22). According to the invention, an additional peripheral manifold (26) is arranged between the storage chamber (20) and the controlled annular nozzle (24) for application of a further plastic layer (outer functional layer) on the previously peripherally extruded plastic carrier. The additional peripheral manifold (26) is connected through a supply line (28) to an additional external storage element (30) for the molten plastic of the functional layer, wherein the additional external storage element (30) has a separate extruder (32).

The present invention relates to an extrusion storage head for a blow-molding machine for producing blow-molded multilayer plastic hollow bodies, wherein two or more peripheral manifolds are arranged above a storage reservoir, from which the plastic material distributed about the circumference can be sequentially ejected via a controllable annular nozzle by a movable annular ejection piston as a tubular parison having two or more layers.

The invention is also directed to a method for producing blow-molded multilayer plastic hollow bodies using this storage head as well as plastic hollow bodies produced in this manner.

Blow-molding machines with an extrusion storage head for producing blow-molded multilayer plastic hollow bodies are generally known, for example from U.S. Pat. No. 5,256,051. When using blow-molding machines with an extrusion storage head for producing multilayer plastic hollow bodies, it is desirable to distribute the plastic layers from different extruders in the corresponding peripheral manifolds circumferentially under nearly identical Theological conditions. The peripheral manifolds are here typically configured to be concentric with respect to one another. However, this arrangement quickly increases the diameter of a storage head when several layers are to be molded.

It is therefore an object of the present invention to obviate these disadvantages and to propose a multilayer extrusion storage head of the afore-described type with a slim design, which can be easily converted to produce special configurations of hollow plastic bodies.

The object is attained with an apparatus having an additional peripheral manifold located below the storage reservoir and the controllable annular nozzle for applying an additional plastic layer external of the plastic material (carrier material) previously distributed about the periphery, wherein the additional annular manifold is connected via a supply line to an additional external storage device for molten liquid plastic material (functional layer) equipped with an additional separate extruder. In this way, an outer thin third layer can be easily “pasted on” or applied on the parison, which was ejected with the ejection piston, by arranging another peripheral manifold downstream below the hollow cylindrical storage reservoir, in which the then “finished” two-layer parison is stored.

According to one embodiment of the invention, the external storage device may also be provided with an ejection piston moveable in a storage reservoir and a shutoff valve disposed below the storage reservoir. The plastic material of the additional layer (functional layer) can then be supplied in parallel or simultaneously with the ejection process of the main storage head or independent thereof.

In a preferred embodiment of the invention, the annular ejection piston may be configured to be movable in the external storage device within a likewise hollow-cylindrical storage reservoir, with a shutoff valve implemented as a needle valve moveably arranged in the center of the hollow-cylindrical storage reservoir. This particular configuration may be used to reproducibly produce various modifications of the process for different embodiments of plastic hollow bodies having particular properties.

A large number of blow-molding machines operating today and used in the production of blow-molded packaging containers are configured as two-layer machines. New or already installed two-layer blow-molding machines can be retrofitted in a simple and fairly cost-effective manner to high-quality three-layer blow-molding machines or multilayer machines capable of operating with another additional plastic layer by configuring the additional peripheral manifold disposed between the storage reservoir and the controllable annular nozzle and the connected supply line as an interchangeable annular assembly.

To keep the overall installation height of the extrusion storage head as low as possible, the additional peripheral manifold may be implemented as an annular distribution channel.

According to another particular embodiment, the annular distribution channel is provided with at least one movable shut-off element (shutoff gate), wherein the shutoff element is arranged on the side facing the supply line, so that the plastic material of the additional functional layer which flows into the annual channel manifold and circulates on both sides in the peripheral direction cannot merge and hence remains spaced-apart by a certain distance. For example, (black, blue) colored containers can be provided with a viewing strip without complicating their manufacture.

The method of the invention for producing blow-molded multilayer plastic hollow bodies from a two-layer or multilayer tubular parison in a blow-molding machine with an extrusion storage head (accumulator head) with two or more peripheral manifolds disposed above a storage reservoir, from which the peripherally distributed plastic material is sequentially extruded with an ejection piston through a controllable angular nozzle, is characterized in that an additional thin plastic layer (outer functional layer) is deposited onto the at least two-layer, peripherally distributed plastic carrier material through an additional peripheral manifold arranged between the storage reservoir and the controllable annular nozzle, wherein the additional peripheral manifold is supplied from an additional external storage device containing molten liquid plastic sequentially or discontinuously material via a supply line.

Several additives are mixed into the outer functional layer depending on the desired properties of the finished container. These additives are typically quite expensive, so that the functional layer is advantageously made as thin as possible so as to keep the required quantities of the expensive additives small.

According to one embodiment of the invention, the plastic layer (=functional layer) applied to the outside of the ejected parison is very thin, having a thickness between 1% and 10%, preferably about 2%, of the wall thickness of the ejected parison or the hollow body produced from the parison. This is advantageous, for example, when additional color pigments are mixed into the externally applied plastic layer (functional layer), causing the functional layer to have a different color from the plastic layer disposed underneath. Because additional color pigments or other additives used to adjust certain properties are normally very expensive, significant cost reductions can be achieved.

For particular applications it may be advantageous to form the externally applied plastic layer, as viewed in the longitudinal direction, not along the entire periphery and/or not as a continuous layer. Instead, at least one discontinuity is provided so that the two opposing edges of the functional layer are spaced by at least a small distance, leaving on the extruded parison a longitudinally extending strip representing a discontinuity. For example, blue or black colored plastic containers, such as canisters, drums or interior containers for palette containers with viewing strips can advantageously be produced by incorporating in the externally applied colored functional layer of the finished blown container the discontinuous strip with a width of about 10 mm to 50 mm, depending on the volume of the produced container.

In other applications, the external plastic layer—as viewed in the longitudinal direction—may be applied not over the entire length of the ejected parison, but may instead only be applied to the extruded parison over a predefined longitudinal segment. This particular embodiment of the method is advantageous, for example, when particular additives (such as nano-clay, metal fibers, conductive carbon, antistatic master batch, polyamide copolymers and the like), which have particular electric or an electrostatic properties, are mixed into the externally applied plastic layer. The plastic hollow body blown from the pre-form can thereby be provided with an electrically conductive or antistatic coating. With the storage head of the invention, the plastic material of the outer layer can be applied in a reduced quantity or not at all in the region of the sprue sections of the produced containers, thereby conserving the comparatively expensive plastic material (with specific additives). It should be noted that with each discontinuous ejection of a tube, about 20% to 40% of the extruded tube length ends up in the sprue sections (=upper and lower sprue sections on the finished blown product). These sprue sections are mixed with new material as re-granulate and employed in an intermediate layer of the produced plastic hollow body. Advantageously, a reduced functional layer or no functional layer at all is applied to the sprue sections.

With respect to the machine concept of the invention, the layer thickness of the outer functional layer is adjusted in the additional external storage device via a controllably change in the ejection speed of the ejection piston. The functional layer can then be produced reproducibly across the ejection length of the tube with a defined wall thickness profile commensurate with the velocity profile of the ejection piston in the additional storage device. The functional layer can then be minimized or entirely eliminated in the region of the sprue sections. The functional layer in the subsequent blow-molded part can then attain a uniform wall thickness even under very different blow-molding conditions and aspect ratios, for example in the lower and upper corner regions of a cube-shaped inner container for a pallet container, whereby a partially thicker functional layer is applied on the extruded parison for the corner regions of the container with very high deformation ratios (partial wall thickness control of the outer layer). This enables optimal use of the material in the functional layer of the blow-molded part to be produced, while minimizing its cost.

A blow-molding machine with the extrusion storage head of the invention has several advantages compared to a two-layer machine: the properties of the produced products can be improved by
an electrostatic surface (permanent antistatic compounds),
an electrically conductive surface (through intermixed conducting carbon),
an optical layer (e.g., blue color pigments) and
light shields and UV stability for light-sensitive fill materials (for example, white color pigments, UV stabilizers).

Material costs are reduced by making the outer layer very thin and by enabling color changes within a very short time.

The extrusion storage head of the invention with a separate storage device and ejection piston for the outer functional layer allows the use and processing of various types of plastic materials, such as high-density polyethylene (HD-PE) and low-density polyethylene (LD-PE), which in form of low-viscosity and high-viscosity polyethylene materials exhibit substantial differences in the viscosities and flow properties of the corresponding plastic melts. The separate storage device with ejection piston enables excellent controllability and reaction speed, for example, by changing the rotation speed of an extruder, which is different from conventional processes, where the pressure in the melt flow is changed.

An exemplary embodiment of the invention will now be described with reference to the following drawings, in which:

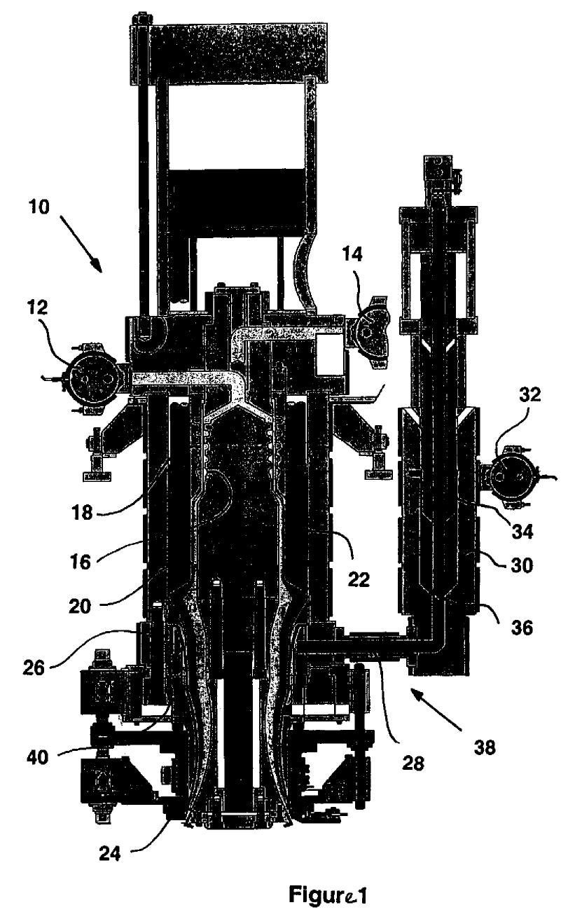

FIG. 1 shows an extrusion storage head according to the invention;

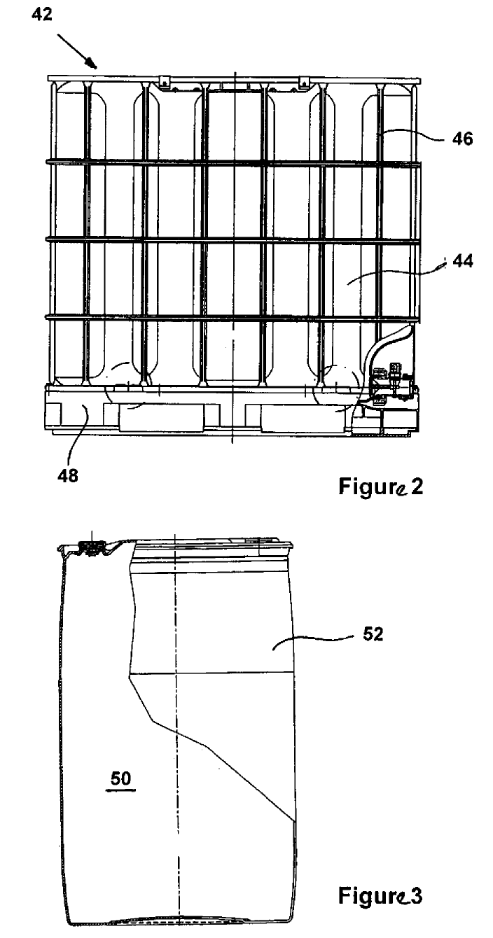

FIG. 2 shows in a side view a 1000 liter palette container; and

FIG. 3 shows a 220 liter plastic L-ring drum.

FIG. 1 shows an extrusion storage head (accumulator head), designated with the reference numeral 10, with two connected extruders 12, 14 for producing a two-layer tubular parison.

The molten plastic material flows from the extruders 12, 14 through two helical channel manifolds 16, 18 (peripheral manifolds) into a storage reservoir 20. The storage reservoir 20 is defined by the wall thickness and the stroke of a hollow-cylindrical ejection piston 22. In the discontinuous operating mode of the storage head, the peripherally distributed plastic material is first collected in the storage reservoir 20 and thereafter sequentially ejected as a tubular parison from the storage reservoir 20 by the ejection piston 22 through a controllable annular nozzle 24. According to the present invention, an additional peripheral manifold 26 is arranged between the storage reservoir 20 and the controllable annular nozzle 24, wherein the additional peripheral manifold 26 is connected to an additional storage device 34 for molten plastic (functional layer) having a separate extruder 32.

In the present embodiment, the additional peripheral manifold 26 is configured as a simple annular channel manifold. The cylindrical storage device 30 has a storage reservoir with an ejection piston 34 movably disposed therein. A moveable shutoff valve 36 configured as a needle valve is guided in the center of the ejection piston 34 formed as a hollow cylinder.

The molten plastic material for the functional layer is continuously supplied from the separate extruder 32 to the storage device 30, with the ejection piston 34 being lifted until the storage place is filled. The plastic material of the functional layer is filled through the supply line 28 into the additional peripheral manifold 26 of the extrusion storage head 10 using the ejection piston 34, from which the plastic material can be pressed into the angular gap guiding the tubular parison—in parallel with the ejection motion of the ejection piston 22—, thereby placing a thin plastic layer (outer functional layer) on top of the previously peripherally distributed main plastic flow (carrier material).

The additional annular-channel peripheral manifold 26 includes a shutoff element 40 implemented as a simple stop valve on the side facing the supply line 28. The annular channel 26 can thereby be partially closed across a predefineable width (closable annular slit).

At least one viewing strip can be formed in the outer wall of a plastic hollow body to be produced at a predeterminable location. This can be attained by not applying the outer plastic layer (functional layer), into which optionally electrically conducting additives and/or color pigment can be admixed, along the entire circumference. The viewing strip is preferably offset by 90° relative to the plane of the mold parting line.

The housing of the additional annular channel manifold is advantageously configured as a modular unit which can be easily inserted into a conventionally constructed two-layer storage head as an intermediate annular assembly 38, which includes the supply line 28, the storage device 30 and the separate extruder 32. The annular assembly 38 with the additional annular channel manifold can be installed in new blow-molding machines or retrofitted in existing two-layer blow-molding machines.

The exemplary embodiment depicted in FIG. 2 shows a pallet container 42 for storing and transporting liquid or viscous charges. The pallet container 42 consists of a thin-wall plastic inner container 44, a lattice framework 46 which tightly surrounds the plastic inner container 44 and is constructed of welded rods, and a plastic bottom pallet 48 which supports the inner container 44 and to which the lattice framework 46 is attached.

For use in explosive areas and/or with flammable goods, the plastic inner container 44 is provided with a thin, antistatic surface layer (antistatic compound).

FIG. 3 shows an additional exemplary embodiment of a 220 liter plastic L-ring drum 50 with an electrically conducting drum surface 52. The thin functional layer is here colored black through addition of conductive carbon.

A three-layer or multilayer plastic container produced with the blow-molding machine of the invention is characterized in that the outer functional layer is formed very thin, representing only between 1% and 10%, preferably about 2%, of the wall thickness of the tubular parison or the finished blown hollow body. The outer layer can have a different color from the intermediate and/or inner layer. In one embodiment, the outer layer may not extend along the entire periphery or may not be completely closed—when viewed in the peripheral direction—, but may include at least one strip-shaped discontinuity, so that the two opposing edges of the cover layer are spaced apart by at least a small gap, rendering the intermediate and/or inner layer visible from the outside. In the finished blown container, the discontinuity in the outer colored functional layer should have a width of at least 10 mm, thus forming at least one narrow strip as a so-called viewing strip which is implemented as a discontinuity in the outer layer in the axial direction. Many types of color pigments can be added to the outer functional layer of the plastic hollow bodies. By using expensive color pigment additives only in the thin outer layer, colored or pigmented containers can be produced cost-effectively.

Recent developments in the area of industrial packages, in particular large volume pallet containers with the capacity of approximately 1000 liters, include so-called antistatic IBC (Intermediate Bulk Container) with transparent, electrically antistatic inner containers. A special outer layer with specially developed, embedded permanent antistatic compounds is applied to these plastic containers. Because these materials (additives) are very expensive and the attained electrical surface resistance is a function of the concentration of the additives in the plastic material, a very thin outer cover layer wall is attained as a functional layer in the extrusion storage head. Due to the small layer thickness of the outer layer, the fill level of the liquid charge in the container can still be easily viewed, thus obviating the need for incorporating viewing strips which tend to be expensive.

### List of Reference Symbols

| | | | |
|---|---|---|---|
| 10 | Storage head | 12 | Extruder I |
| 14 | Extruder II | 16 | Helical channel manifold I |
| 18 | Helical channel manifold II | 20 | Storage reservoir |
| 22 | Ejection piston | 24 | Annular nozzle |
| 26 | peripheral manifold (annular | 28 | Supply line |
| | channel) | | |
| 30 | Storage device | 32 | Extruder III |
| 34 | Ejection piston II | 36 | Shutoff valve (needle valve) |
| 38 | Annular assembly | 40 | Shutoff element (gate) |
| 42 | Pallet container | 44 | Plastic inner container |
| 46 | Lattice framework | 48 | Plastic bottom plate |
| 50 | Plastic L-ring drum | 52 | Drum surface |

1.-13. (canceled)

14. An extrusion storage head for a blow-molding machine for producing blow-molded multilayer plastic hollow bodies, comprising:
a first storage reservoir containing a plastic material,
a movable first annular ejection piston receiving the plastic material for distribution about a periphery of the extrusion head and sequential ejection through a controllable annular nozzle as a tubular preform having two or more layers,
a plurality of peripheral manifolds arranged above the first storage reservoir, and
an additional peripheral manifold arranged below the first storage reservoir and above the controllable annular nozzle for applying an additional plastic layer (outer functional layer) onto the tubular preform with the two or more layers, wherein the additional annular manifold is connected by way of a supply line to an additional external storage device for molten liquid plastic material (functional layer) having an additional separate extruder.

15. The storage head of claim 14, wherein the additional external storage device includes a second annular ejection piston moveable in a second storage reservoir and a shutoff valve disposed below the second storage reservoir.

16. The storage head of claim 15, wherein the shutoff valve is implemented as a needle valve.

17. The storage head of claim 16, wherein the second annular ejection piston is configured for movement in a hollow-cylindrical storage reservoir of the second external storage device, with the needle valve being moveable in a center of the hollow-cylindrical storage reservoir.

18. The storage head of claim 14, wherein the additional peripheral manifold is arranged together with the connected supply line to form an exchangeable annular assembly.

19. The storage head of claim 14, wherein the additional peripheral manifold is implemented as an annular channel manifold.

20. The storage head of claim 19, wherein the annular channel manifold comprises a movable shut-off element (shutoff gate) disposed on a side of the annular channel manifold facing the supply line.

21. A method for producing blow-molded multilayer plastic hollow bodies with two or more layers from a tubular preform in a blow-molding machine having two or more peripheral manifolds disposed above a storage reservoir, comprising the steps of:
sequentially extruding a peripherally distributed plastic material received from the storage reservoir by an ejection piston through a controllable annular nozzle to form a carrier, and
depositing an additional thin plastic layer (outer functional layer) onto the carrier
with an additional peripheral manifold arranged between the storage reservoir and the controllable annular nozzle,
wherein the additional peripheral manifold is supplied with molten liquid plastic material from an additional external storage device, either sequentially or discontinuously, via a supply line.

22. The method of claim 21, further comprising the step of changing an ejection speed of a second ejection piston disposed in the additional external storage device during an ejection process to adjust a layer thickness of the additional thin plastic layer disposed on the carrier.

23. The method of claim 21, further comprising the step of adjusting a length of the additional thin plastic layer on the carrier by opening and closing a valve disposed in the supply line with a time delay, such that the plastic hollow body, after being finished and removed from the blow-mold, is covered with a uniform thin functional layer, whereas upper and lower connected sprue sections are only partially, or only slightly, or not at all, covered with the functional layer.

24. A plastic hollow body produced in a blow-molding machine from at least one three-layer tubular preform having a comparatively thin inner layer made of new material (virgin material), a comparatively thick intermediate layer made essentially of re-granulate, and an outer comparatively thin functional layer made of new material and comprising additives selected from the group of color pigments, UV stabilizers, plasticizers, antistatic compounds, and conductive carbon.

25. The plastic hollow body of claim 24, wherein the inner layer made of new material has a layer thickness of about 5% to 30%, the intermediate layer made of re-granulate has a layer thickness of about 50% to 93%, and the outer functional layer has a layer thickness of about 2% to 20% of an average total wall thickness of the plastic hollow body.

26. The plastic hollow body of claim 24, wherein the outer functional layer is discontinuous along the periphery at at least one location in a longitudinal direction of the plastic hollow body, wherein edges of the discontinuous functional layer are spaced apart, leaving at least one narrow unobstructed longitudinal stripe having a width of about 10 mm to 40 mm, thereby rendering the plastic layer located below visible.
